(19) United States
(12) Patent Application Publication
(10) Pub. No.: US 2005/0236490 A1
(43) Pub. Date: Oct. 27, 2005

(54) Chip card device for transmitting digital information using acoustic means

(76) Inventors: Jean-Pierre Fortune, Paris (FR); Jean-Etienne Bougnoux, Courbevoie (FR)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/507,988

(22) PCT Filed: Mar. 14, 2003
(86) PCT No.: PCT/FR03/00828

§ 371 Date: Jun. 30, 2005

(30) Foreign Application Priority Data
Mar. 15, 2002 (FR) 02/03206

(51) Int. Cl. G06K 19/06

(52) U.S. Cl. 235/492

(57) ABSTRACT

A device for transmitting information by acoustic means, the device being constituted by a smart card of standardized format incorporating at least one microcircuit for generating signals for directly exciting a sound transducer, and an independent complementary unit, wherein said unit incorporates at least one smart card connector, an electric battery for providing electrical power to the microcircuit of the smart card, and the sound transducer for emitting the excitation signals transmitted by said smart card.

The present invention relates to a smart card device for transmitting digital information by acoustic means, e.g. to a remote server for authentication purposes and via a telephone or the microphone of a multimedia microcomputer.

### BACKGROUND OF THE INVENTION

Various devices are known that emit authentication information acoustically, and in particular cordless units, various cards, optionally of International Standards Organization (ISO) format, incorporating sound-production means, generally a lithium battery, and a piezoelectric ceramic disk, or indeed cordless readers entirely analogous to conventional smart card readers but communicating with the outside not by cable but by acoustic modem.

Each of those devices presents drawbacks:
cordless units do not come within the context of smart card industry, and as a result they do not benefit from the performance of production tools (costs, personalization services, management procedures), nor do they benefit from a format that is recognized worldwide for payment or credit cards. In addition, those units are not compatible with existing smart cards;
ISO format cards that include acoustic transmission means are difficult to manufacture, fragile, and expensive; and
readers with an acoustic modem need to carry the software required for processing cards, and as a result they are expensive and not very flexible, and in addition it is difficult to encourage a large part of the public to adopt use thereof.

### OBJECTS AND SUMMARY OF THE INVENTION

The device of the present invention relies on concepts that remedy the main drawbacks of those techniques. According to first characteristic, the device comprises a smart card and a complementary unit, e.g. in the form of a case into which the smart card can be inserted. According to a second characteristic of the device, the smart card incorporates electronic means for generating signals for exciting a sound transducer, the complementary unit incorporates at least one sound transducer and a battery necessary for supplying electrical energy. Without it being essential for operation of the device of the invention, the unit may include an activation button to trigger sound emission by the device; such triggering could alternatively be consecutive to the card being inserted in the unit. The smart card and the unit are interconnected via a standardized connector for smart cards. In particular, the transducer excitation signals pass via unallocated contact points C₄ and C₈ defined by ISO standard 7816. When the smart card is inserted, its electronic component is powered by the unit via standardized contacts C₆ (also referred to in the standard as VPP), and C₅ (GND). Information concerning activation of the key is transmitted via contact C₂ (RST) which is connected to a chip input signal with pull-up, the reference voltage being the ground contact C₅ (GND).

According to an important advantage of the invention, the electrical contacts between the smart card and the complementary unit do not in any way harm compatibility between the smart card and other environments, and in particular with known uses for standard smart card readers.

A second important advantage of the device of the invention is that the smart card is in fact dissociated from the complementary unit. Thus, the function of emitting information acoustically can be provided solely at the time when it is needed, for example, when performing a check in an application of the smart card as an identity (ID) card. Since the main part of the extra cost of the acoustic interface lies in integrating the battery and the transducer, this extra cost is not borne by each card that is issued.

A variant of the invention consists in fitting the complementary unit with a keypad and giving the smart card additional communications means enabling it to read the state of the keypad, i.e. the references of the keys that have been pressed. When a card is inserted in the unit, a key press is detected by means of an integrated circuit incorporated in the unit, and electrically powered by the battery. The integrated circuit is provided with a communications interface enabling it to use a single signal to inform the smart card of any change in the state of the keypad, and to transmit the state of the keypad to the smart card on request.

Under such circumstances, the controlling integrated circuit of the keypad is slaved to the smart card, with information being transmitted conventionally via a synchronous type serial communications bus constituted by a clock signal and a data signal. Once a key press has been detected, the circuit informs the smart card of a change in the state in the keypad, and the smart card can then decide to read the new state by sending a read command to the integrated circuit controlling the keypad via the available serial communications bus.

Advantageously, the keypad can be used to present a secret code to the smart card that is known only to the user and that is used, for example, as a complement to authenticating the card in order to verify the identity of its bearer.

The ease of use of the device can advantageously take advantage of the presence of the sound-generating means for assisting the user in inputting the code, and for indicating that the code has been taken into account.

### BRIEF DESCRIPTION OF THE DRAWINGS

The accompanying drawings, given by way of example, illustrate the invention:

FIG. 1 is a diagrammatic transparent view of the device of the invention comprising the smart card and the complementary unit in which the card can be inserted;

FIG. 2 shows a variant of the device in which the smart card includes another variant of the device in which the complementary unit is not provided with a keypad; and

FIG. 3 shows another variant of the device in which the complementary unit is provided with a keypad.

### MORE DETAILED DESCRIPTION

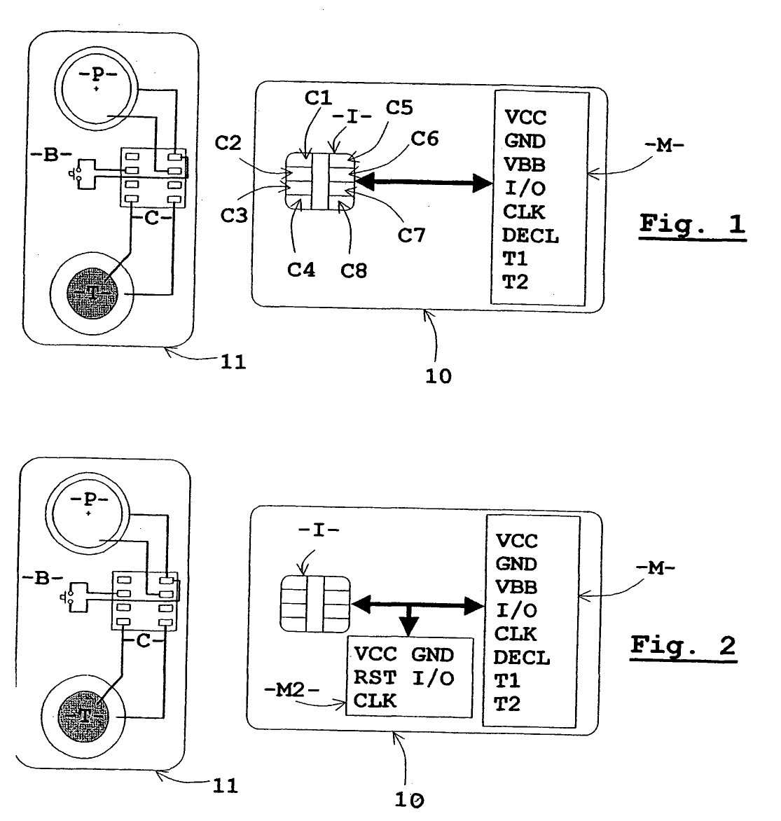

In a first particular embodiment of the invention as shown in FIG. 1, the smart card 10 includes a microcircuit M having a standardized power supply and communications interface I using contacts. The microcircuit M operates in two modes: a first mode known as “slave” mode when the smart card 10 is inserted in a smart card reader; and a second mode known as “independent” mode when the card is inserted in a complementary unit 11 of the device of the invention. The complementary unit 11 includes at least one connector C having contacts suitable for co-operating with the interface I of the card 10, an activation key B, a battery P, and a sound transducer T.

When the microcircuit M operates in slave mode, electrical power is conventionally supplied by the smart card reader via contact points C₁ (VCC) and C₅ (GND). Communication between the microcircuit M of the card and the reader is provided by the two-way signal C₇ (I/O), the driving clock being C₃ (CLK). In this embodiment, the microcircuit M is provided with an internal reset signal, automatically operated by being switched on. The signal RST (C₂) is therefore not used in the slave mode of operation. Operation of the smart card 10 of the device of the invention in this mode is well known to the person skilled in the art since it is in compliance with ISO standard 7816. This mode is used in particular to personalize the microcircuit M during the process of manufacturing the product.

When the microcircuit M is operating in independent mode, its electrical power is supplied by the battery P of the complementary unit 11 of the device of the invention via the contact points of the connector C corresponding to C₆ (VPP in the standard) and C₅ (GND), contact point C₆ being connected to the power supply input VBB of the microcircuit M. Contact C₂ (RST) is connected to the activation key B by providing a connection to ground C₅ (GND) on being pressed by a finger, the corresponding signal at the microcircuit M being referenced DECL. When a change in the logic state of the signal DECL is detected by the microcircuit M, it triggers acoustic emission by generating signal trains for exciting the sound transducer T of the complementary unit 11. These signals generated by the microcircuit and referred to as T₁ and T₂ are transmitted to the sound transducer T via the contact points of the connector C that correspond to C₄ and C₈.

The sound produced by the microcircuit M conveys digital information, e.g. for the purpose of authenticating the card. It is demodulated by signal processor means which transform the analog sound signal into digital information.

In a second particular embodiment of the invention as shown in FIG. 2, the complementary unit 11 of the device of the invention remains identical to that described for the first embodiment, and the smart card 10 reproduces the same principles as specified for the first embodiment. It further includes a second microcircuit M₂ for the smart card which is connected to the communications and power supply interface I. Conventional microcircuits for smart cards, e.g. for bank cards, make use essentially of five out of the eight points of the interface defined by the standards: C₁ (VCC), C₂ (RST), C₃ (CLK), C₅ (GND), and C₇ (I/O); their communications protocol with readers is of the asynchronous type.

The two circuits in this embodiment of the invention are connected together in parallel with the interface I. The device of the invention makes this possible since VCC and GND are common to both microcircuits M and M₂. Given the low electrical power consumption of the electronic components, this does not lead to any problem with the reader which is required by the standard to be capable of delivering electricity at levels much greater than those consumed by the two microcircuits.

The microcircuits of present-day smart cards no longer make use of the signal C₆ which was previously used as a programming voltage in memory technologies that have become obsolete. In a standardized procedure, readers are required to maintain this signal at 0 volts on request of the card. The microcircuit M that performs acoustic modulation can therefore occupy the contact C₆ without leading to disturbance for its own power supply in the independent mode described for the preceding embodiment.

Cohabitation between the signals C₂ (RST), C₃ (CLK), and C₇ (I/O) does not lead to problems since the signals are either input signals or signals that are subject to the use of internal pull-up resistors enabling them to be connected in parallel, and since the communications protocols are different (synchronous/asynchronous), communication between a reader and either particular one of the microcircuits will be ignored by the other microcircuit, and vice versa. Furthermore, since the contact points C₄ and C₆ are not allocated by the standard for asynchronous type microcircuits, they are free for use by the microcircuit M.

This embodiment of the invention is useful for adding an additional application, namely the ability to transmit information acoustically, to a card that is already being distributed without this ability. For example, it is possible to add the function of authenticating the card by recognizing the acoustic sequence in a server to a bank card of a kind that already has a chip.

In a third particular embodiment of the invention (not shown), the complementary unit of the device of the invention remains identical to that described in the first two embodiments, and the smart card reproduces overall the principles set out for the first two embodiments, however it has a single microcircuit in the smart card connected to the communications and power supply interface. This microcircuit comprises combining the two microcircuits M and M₂ of the second embodiment into a single microcircuit.

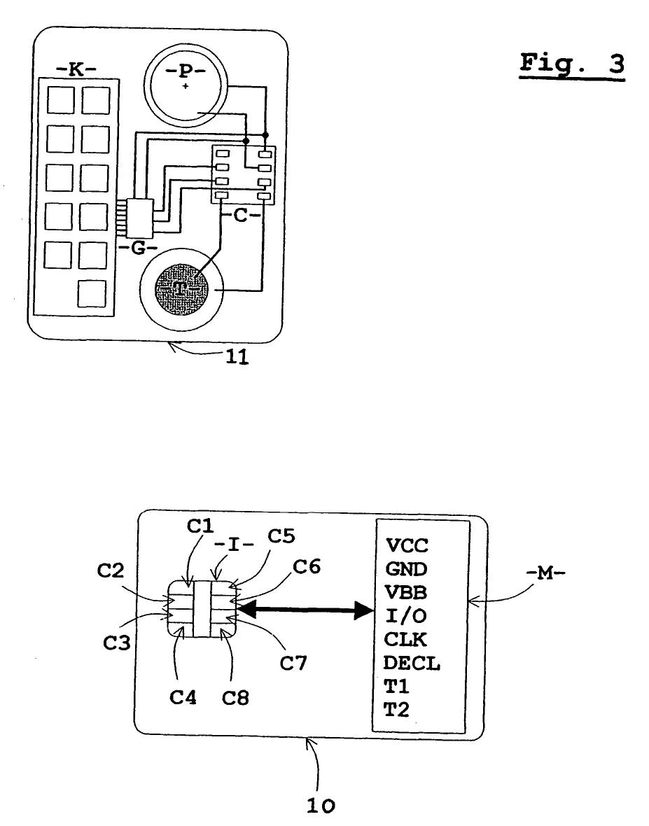

In a fourth particular embodiment of the invention as shown in FIG. 3, the complementary unit 11 includes a keypad K and an integrated circuit G for controlling the keypad. When the smart card 10 is inserted in the complementary unit 11, if a key of the keypad K is pressed, then the integrated circuit G detects a change in the state of the keypad and informs the smart card by activating the signal corresponding to point C₂ of the interface I. The smart card 10 can then launch a procedure for reading the state of the keypad K over the communications bus constituted by the signals CLK and I/O connected to the integrated circuit G via the points C₃ and C₇ of the interface I. The keypad 10 may comprise, in particular, ten keys corresponding to the ten digits, plus an eleventh key corresponding to the command for triggering sound emission.

In each of the embodiments, industrial implementation of the device consists firstly in making a standard smart card whose micromodule incorporates the microcircuit(s) as described, and secondly in making a complementary unit including a smart card insertion slot. The unit incorporates a battery, a sound transducer, and an activation key, and may be in the form of an object having approximate dimensions of 60 millimeters (mm) in length, 30 mm in width, and 7 mm in thickness. The unit may also be provided with a fastener system enabling it to be used as a key ring.

1. A device for transmitting information by acoustic means, the device being constituted by a smart card of standardized format incorporating at least one microcircuit for generating signals for directly exciting a sound transducer, and an independent complementary unit, wherein said unit incorporates at least one smart card connector, an electric battery for providing electrical power to the microcircuit of the smart card, and the sound transducer for emitting the excitation signals transmitted by said smart card.

2. A device according to claim 1, in which the electrical excitation signals for the transducer leaving the microcircuit of the smart card correspond to contact points C₄ and C₈ of a communications and power supply interface as defined by ISO standard 7816.

3. A device according to claim 1, in which the complementary unit includes an activation key for causing the smart card to generate the signals for exciting the sound transducer of said unit.

4. A device according to claim 1, in which the complementary unit incorporates a keypad and an integrated circuit controlling the keypad.

5. A device according to claim 1, in which the complementary unit is in the form of an object having length of about 60 mm, width of about 30 mm, and thickness of about 7 mm.
